(19) United States
(12) Patent Application Publication
(10) Pub. No.: US 2011/0233154 A1
(43) Pub. Date: Sep. 29, 2011

(54) Motorcycle Chock Stand

(76) Inventor: Charles George St. Louis, Guatemala (GT)

(21) Appl. No.: 12/749,508

(22) Filed: Mar. 29, 2010

(51) Int. Cl. F16M 11/04

(52) U.S. Cl. 211/13.1

(57) ABSTRACT

This invention is a stand or chock used to park the heaviest of motorcycles. It is extremely easy to enter and exit the chock/stand even when not fixed or bolted to the floor. The smallest of operators will appreciate the ease, safety, and control during the removal of the motorcycle from the chock accomplished with a very light push of a pedal or use of the linear actuators. Commercial establishments such as a motorcycle dealers with many and varying sized motorcycles will like the fact that this motorcycle chock needs no adjustment one size fits all. Because it is so easy to eject the motorcycle from the stand an automatic locking and disconnect system is provided to prevent accidental removal.

### CROSS-REFERENCE TO RELATED APPLICATIONS

WO 96/38336

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING

N/A

### REFERENCE TO SEQUENCE LISTING, A TABLE, OR A COMPUTER PROGRAM LISTING COMPACT DISC APPENDIX

N/A

### FIELD OF INVENTION

This invention relates to stands or chocks for wheeled vehicles. More specifically, the invention relates to stands for supporting two wheeled vehicles such as motorcycles in an upright position.

### BACKGROUND OF INVENTION

### Discussion of the Prior Art

Motorcycles and other two-wheeled vehicles are conventionally supported when stationary by a pivoting mounted cradle secured to a base frame. The vehicle's tire rolls into a lower cradle which pivots over center and the tire is captured by the top cradle or nested into an angled vertical tower thus supporting the two wheeled vehicle by the front tire. In patent WO 96/38336 describes a mechanism in which a stand is equipped with an upper and lower cradle. The lower cradle has a lever which can be depressed by an operators foot causing the lower cradle to pivot back over center, hopefully ejecting the two wheeled vehicle out and away from the stand/chock. U.S. Pat. No. 6,640,979

The over center design of the lower cradle has the characteristic that with one moving part IE the lower cradle, the two wheeled vehicle can be held in a secure manner without any other additional locking mechanisms. The other advantage of the over center design of a chock is that once the motorcycle is placed in the stand it takes the same amount of force to pull the motorcycle out of the chock as it took to place it in the chock. This characteristic makes the over center chock secure. The problem is that with the popularity of large motorcycles there is the difficulty in entering the chock while parking if the chock/stand is not fastened to the surface or ground or placed against a stop. The stand tends to slide away from an incoming motorcycle. The Second problem is that the same force required to place the motorcycle into the chock is also required to extract the vehicle. That force is beyond the capability of many typical operators. In U.S. Pat. No. 6,640,979 has a clever and well designed lower cradle clamping system that grabs the tire as the weight of the motorcycle goes over center. The idea is to release the tire from the clamping pressure as the motorcycle is pulled back and thereby lower the surface cohesion. It is my experience the force required to eject the motorcycle from the chock is not so much due the stickiness of the contact surfaces of the vees, but the force needed to get the wheel up and over center of the lower chock cradle.

### BRIEF SUMMARY OF INVENTION

These and other problems can be overcome with the following invention. The operation of the chock can be improved and made easier to use by placing and attaching a hoop or curved rail to the top and front of the lower cradle. Provide levers that cause the lower cradle to rotate. Provide linear actuators that push or pull the upper cradle or lower cradle. Provide an extended strap of flexible or rigid material fixed to the base and entrance of the lower cradle. Provide a chock with a tension spring. Accordingly, It is the object of this invention to provide a motorcycle chock that makes it easier to place the vehicle in the chock. The motorcycle when parking it, won't push the chock forward even if it is not fixed to the ground/surface.

It is the object of this invention to provide a motorcycle chock that makes it easy to remove the vehicle from the chock. When removing the vehicle from the chock it won't pull the chock backward even if it is not fixed to the ground/surface.

It is the object of this invention to provide a chock with an automatic and semi-automatic safety locking mechanism that can be locked with a lock.

It is the object of this invention to provide a chock that pushes or pulls the motorcycle out of the chock under hydraulic, pneumatic, or screw using electrical power using switches to activate, or using a remote controller as used for car doors etc.

It is the object of this invention to provide a motorcycle chock that can be ejected by depressing a lever with the operator's foot.

It is the object of this invention to provide a motorcycle chock that has a foot lever attached to the lower cradle that automatically disconnects when motorbike is parked and placed in the chock. The foot lever can then be folded forward and locked as needed.

It is the object of this invention to provide a motorcycle chock that easily off loads a parked motorcycle even without the use of a pedal or axillary power.

### DESCRIPTION OF DRAWINGS

FIG. 1 General layout of chock with hoop & flexible restrainer strap in empty position.

FIG. 2 General layout of chock with hoop & flexible restrainer strap in closed position.

FIG. 3 Lower cradle with extension lug.

FIG. 4 General layout of chock with bucket & rigid restrainer strap.

FIG. 5 Three different types of lower cradle frames.

FIG. 6 Cradle layout with hinged rigid restrainer strap in open and closed positions.

FIG. 7 Base frame with restraining material fixed between side rails.

FIG. 8 Base frame with restraining plate fixed between side rails with teeth

FIG. 9 Altered hinged bushing that limits strap movement.

FIG. 10 Front latching mechanism.

FIG. 11 Linear actuator used to rock cradle from near back.

FIG. 12 Linear actuator used to rock cradle in front of pivot point.

FIG. 13 Linear actuator used to rock cradle from front and between base frame.

FIG. 14 Linear actuator to rock lower cradle using linkages.

FIG. 15 Linear actuator used to rock upper cradle below pivot point.

FIG. 16 Linear actuator used to rock upper cradle above pivot point.

FIG. 17 Lever that uses pivot point of lower cradle but moves independently.

FIG. 18 Lever that uses it's own pivot point apart from the lower cradle and moves independently.

FIG. 19 Lever fixed to lower cradle at it's axis that pivots with the cradle.

FIG. 20 Free swinging lever with same axis as bottom cradle and acts on under side of bottom cradle.

FIG. 21 Lever and flat bar acting on cradle that pivots on its own axis.

FIG. 22 Foot pedal and linkage system to move cradle.

FIG. 23 Foot pedal and linkage system to move cradle (detail view)

FIG. 24 Pole and strap cradle rocker.

FIG. 25 Tension spring between lower cradle and side rails that pivots on a lever which pivots on the side rails

FIG. 26 Tension spring between lower cradle and side rails

FIG. 27 Electric motor driven screw rocker mechanism.

FIG. 28 Automatic disconnecting mechanism between lower cradle and foot lever using a link.

FIG. 29 Pivoting foot lever with angular hinge

FIG. 30 Top view of rotated foot lever and locking device.

FIG. 31 Automatic disconnecting mechanism between lower cradle and foot lever using a piston.

FIG. 32 Triangular base.

### DETAILED DESCRIPTION OF INVENTION

### Technical Problem

1. One of the inherent problems when parking a motorcycle into a chock or stand is that, when the front tire comes into contact with the lower cradle, the motorcycle will push and cause the stand to slide forward and away from the vehicle, making it difficult for the front wheel to enter the chock as required. This problem can be remedied by bolting the chock down to the surface it rests on or placing the chock stand against a stop such as a wall or curb or any other fixed obstruction or person.
2. When a motorcycle is placed in the over-center chock it is done under power or with momentum. That same force is needed to eject the motorcycle from the chock. Many heavier motorcycles, such as Harley Davidson, have no reverse gear and the force needed to eject the motorcycle is beyond the capability of many users. The energy required to pull the motorcycle out of the chock puts a lot of strain on the back and knees of the operator. If the surface the chock rests on is slippery the operator when exerting pressure to release the motorcycle from the chock can slip and fall. Even motorcycles with reverse mode experience difficulty and have less control as the motorcycle comes out of a regular over center chock. Once a motorcycle with reverse mode goes over center, some quick coordinated movements are needed to keep the motorcycle from exiting the chock too quickly. It has been known that, because of the violent movement required to eject the motorcycle, in some cases the operator will slip and fall, damaging person and machine.

### Technical Solution

These and other problems can be overcome with the following invention. Place and attach a hoop or curved rail to the top and front of the lower cradle. Or extend the front of the lower cradle with a bucket/pan or bar. Provide the chock with an automatic locking and latching mechanism. Place angled vertical flat bars at the entrance and back of the lower cradle. Provide levers that push on the tire or the underside of the lower cradle that pivots on the same axis as the lower cradle or their own axis. Provide linear actuators that push or pull the lower cradle or upper cradle. Provide an extended strap of flexible material fixed to the base and entrance of the lower cradle. Provide an protrusion of rigid material at the back of the lower cradle. Provide an extended strap of rigid material fixed with a hinge to the lower cradle base and at the back and entrance. Provide a hinge that limits the angular movement of the extended strap. Place and fix a plate or flexible material between the side rails to the back of the lower cradle. Place and fix a plate or flexible material between the side rails and behind the lower cradle with serrations or teeth. Provide a chock with an electric motor and screw mechanism. Provide a chock with a tension spring. Provide a chock with a torsion spring. Provide a chock with a long vertical lever. Provide a chock with linkage arrangements that can be moved by a foot lever or a linear actuator.

### Advantageous Effects

Accordingly, It is the object of this invention to provide a motorcycle chock that makes it easier to place the vehicle in the chock. The motorcycle when parking it won't push the chock forward even if it is not fixed to the ground/surface.

It is the object of this invention to provide a motorcycle chock that makes it easy to remove the vehicle from the chock. When removing the vehicle from the chock it won't pull the chock backward even if it is not fixed to the ground/surface.

It is the object of this invention to provide a chock with an automatic and semi-automatic safety locking mechanism that can be locked with a lock.

It is the object of this invention to provide a chock that easily pushes or pulls the motorcycle out of the chock under hydraulic, pneumatic or electrical power.

It is the object of this invention to provide a motorcycle chock that can be easily ejected by depressing a lever with the operator's foot.

It is the object of this invention to provide a motorcycle chock that is easy to off load a parked motorcycle even without the use of a pedal or axillary power.

### BEST MODE OF OPERATION

A. In order to park a motorcycle in the chock without the chock sliding away from the incoming two wheeled vehicle, an extended strap of material is left or placed and fixed to the entrance of the lower cradle. Therefore before the front tire, if that being the case, of the motorcycle comes into contact with the lower cradle's vees, the weight of the motorcycle is placed and rolled on top of the said strap or extension. The strap/extension is then pinched between ground/platform and said tire. The weight exerted by the motorcycle on the front tire provides the needed friction and retains the strap/extension which is connected to the chock, thereby holding everything firmly in the same place. Again because the front tire of the motorcycle is on the strap, the weight of the motorcycle prevents the chock base from sliding away as the wheel hits the lower cradle and tries to go over-center. The motorcycle's own wheel therefore restrains the chock making it easy to load and park the motorcycle even if the said chock is not fixed physically by bolts or prevented from moving by a wall or curb etc. as previously mentioned.

B. By placing and attaching a hoop or curved rail to the lower cradle of said chock which engages the front tire, the process of ejecting the motorcycle is accomplished easily. Also by extending the lower cradle with a bucket or pan in the same way, ejection of the motorcycle will be executed easily. As the ejection mechanism of the lower cradle is activated, the lower cradle rotates with the hoop or bucket and pulls the tire back and out of the chock/stand easily without the need for the operator to physically pull backwards. This is different from patent WO 96/38336 in that no hoop or bucket with material forward of the vees was included in the design. An extra effort has to be made by the operator to simultaneously pull backward and up as the pedal or leaver is depressed so as to eject the motorcycle. The operator with this new invention will find it easy to sustain the motorcycle in the upright position, maintaining good control during the ejection processes because it can eject gently as required.

C. This invention (a chock equipped with the lever and hoop/bucket mechanism attached to the lower cradle) makes it extremely easy for any person or child to eject even the heaviest motorcycle from the chock. The motorcycle, once mounted in the chock, is very secure and stable until the pedal is depressed. In the event that the pedal were to be depressed by an unknowing person or child, the motorcycle would roll out and away from the stand, possibly falling and causing damage to persons or machine. To prevent such an event, the chock of this invention is provided with a few choices of automatic locking & disconnecting mechanisms. In one system the lower cradle has a link that automatically disconnects between the lower cradle from the foot lever as the vehicle is removed. The foot lever can be rotated forward and locked if needed. To remove motorcycle the arm is rotated back into place and the link is connected. In yet another system herein the latching mechanism is made in such a way that the lower cradle is prevented from pivoting and therefore the bike stays locked over-center even if the ejection lever were depressed. The latching mechanism has a remote release lever that needs to be moved (usually with the operators foot) which then allows the function of the ejection lever. After the release lever is moved and the motorcycle is removed from the chock, to re-enter the chock, the latching mechanism automatically resets and locks the lower cradle as the motorcycle is placed back into the chock without any input from the operator. This latching mechanism has a hasp and can be locked with a conventional padlock.

### DESCRIPTION OF FIGURES

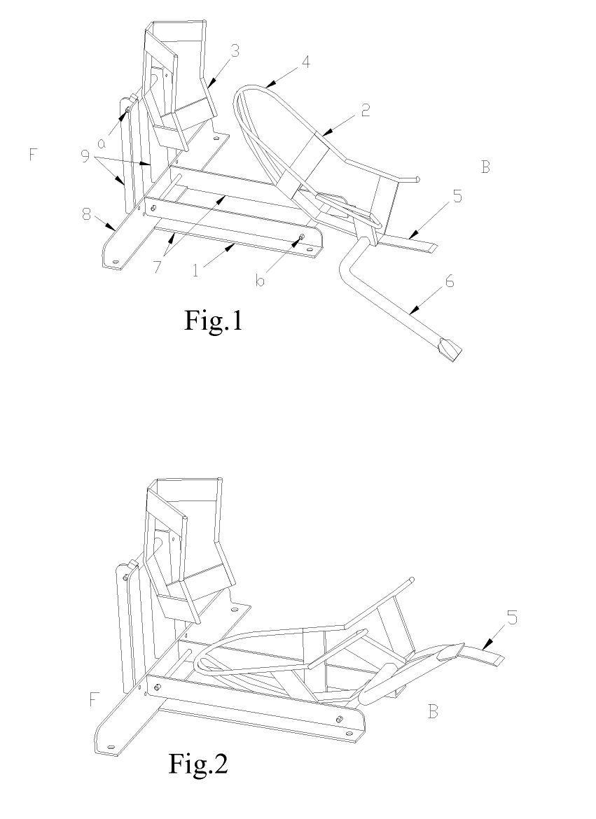

In FIG. 1 shown is a pivoting dual cradle type of motorcycle chock in the position as if it were empty, and is therefore ready to receive a vehicle. The base frame 1 consists of two side rails 7, one front cross member 8. and two vertical rails 9. The base frame 1 has the lower cradle 2 which pivots at point b between the two side rails7. The upper cradle 3 pivots between the two vertical members 9 of the base frame at axis a. As shown in FIG. 1 there is a hoop 4 that is fixed to the front of the lower cradle which wraps around, allowing a wheel of a motorcycle to engage the vees of the cradle without interference. The chock has an attached restraining strap 5 mounted to the back of the cradle which extends out past the back and entrance of the cradle. Pictured strap 5 is made from flexible material. The strap could be made long enough to engage both tires of the motorcycle if desired. This strap prevents the chock from moving. For instance, if the chock is not fixed to surface or ground, the wheel of the vehicle, when it makes contact with the vees of the lower cradle, will not move because the weight of the motorcycle is on the strap. Foot lever 6 is attached to the lower and back of the cradle and is used to rotate the cradle while removing the wheeled vehicle. The capital letter F indicates the front end of the chock and the capital letter B indicates the back end or entrance of the chock.

In FIG. 2 shown is the same chock as FIG. 1 except it is in the closed position. This is the position when a motorcycle wheel is captured in the chock. The capital letter F indicates the front of the chock and the capital letter B indicates the back of the chock.

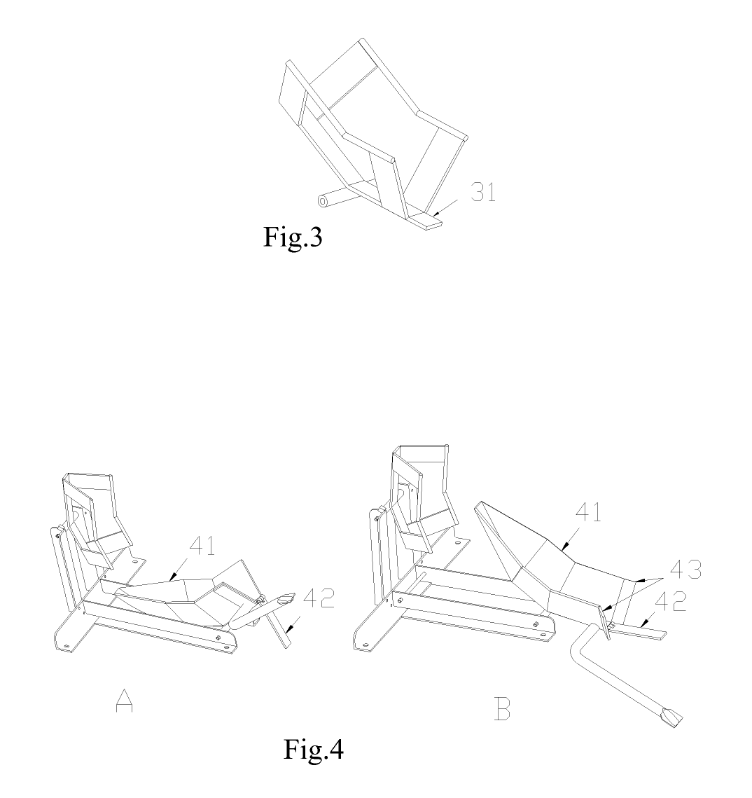

In FIG. 3 Shown is a bottom cradle with a solid protrusion sticking out rearwards of the vees. This is utilized so that the weight of the tire of an incoming vehicle is on the protrusion before the tire hits the vees. That would restrain the chock from moving during the parking process.

In FIG. 4 The chock is equipped with a bucket 41 instead of a hoop and has a hinged stiff metal retainer strap 42 attached to the lower cradle with a hinge. Shown in diagram A is the lower cradle as if the tire were engaged and captured by the chock in the closed position. In diagram b shown is the lower cradle position with a wheel and tire disengaged, i.e the open position. The bucket in diagram B has vertical bars 43 on each side and at the back of the bucket. These bars are used to help guide the tire into the lower cradle when mounting the motorcycle.

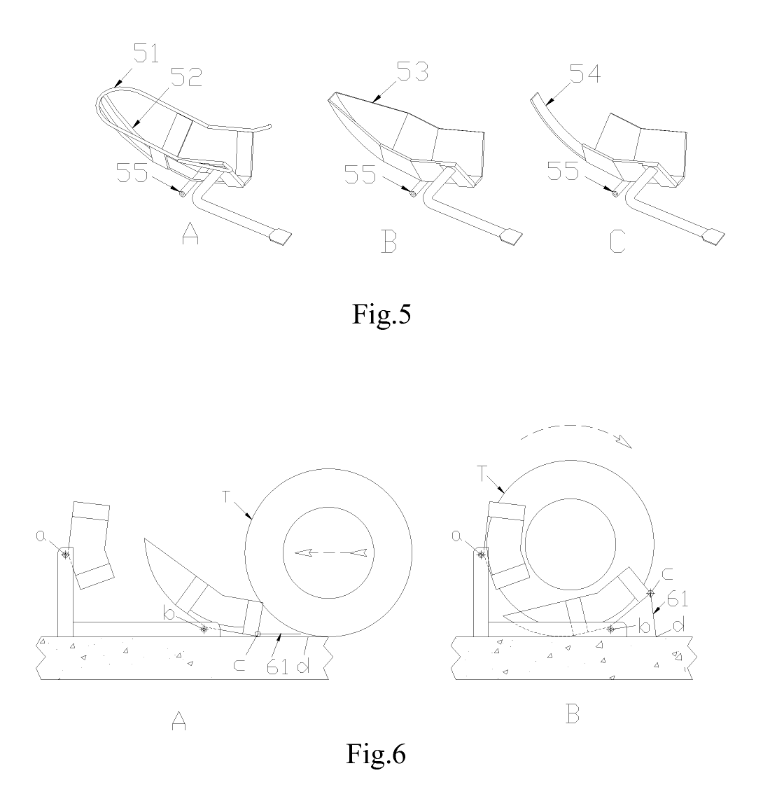

In FIG. 5 shown is the three different types of lower cradles made to pull and eject the tire out of the chock. In diagram A is hoop 51 which wraps around the front part of the lower cradle. The hoop is shown with a round cross-section but could be made with flat, or square bar as required. This layout has strap 52 which helps to provide support for hoop 51 and can be used to fix other components if needed. Hoop 51 primary function is to push the tire of the motorcycle back and out of the chock. Diagram B shows the lower cradle formed in the shape of a bucket. The frontal part of the bucket 53 has a primary function is to push on the tire of a motorcycle and eject the vehicle. The bucket in general could be stamped out of sheet metal or built up of pieces as needed. In diagram C is a lower cradle with a strap 54 which if made of substantial solid material could be used to pull and eject the tire out of the chock without further modification or support there by replacing the hoop 51 on diagram A and the frontal portion 53 of the bucket in diagram B.

In FIG. 6 Is a side elevation view of the chock assembly. The doughnut shaped circles indicated by the letter T is used to represent the motorcycle tire in the rest of this document. Where the tires are behind objects hidden lines are omitted for the sake of clarity of the mechanisms. The dashed lines with arrows on one or both ends indicate the possible movements of the elements adjacent. The upper cradle always pivots at point a and the lower cradle always pivots at point b. At the entrance or back of the lower cradle fixed with a hinge, is the rigid strap 61. The strap 61 pivots at point c and lays down on the ground/surface d when the chock is empty as shown in diagram A. When the tire makes contact and it's weight is on strap 61 the chock is refrained from moving or sliding on the ground. In diagram B the lower cradle has pivoted over-center at pivot point b and the wheel of a vehicle is captured by the chock. The rigid strap 61 has pivoted at point c and makes contact with surface d. Strap 61 now wedges between the lower cradle and the ground, preventing ejection of the vehicle if the ejection mechanism were actuated.

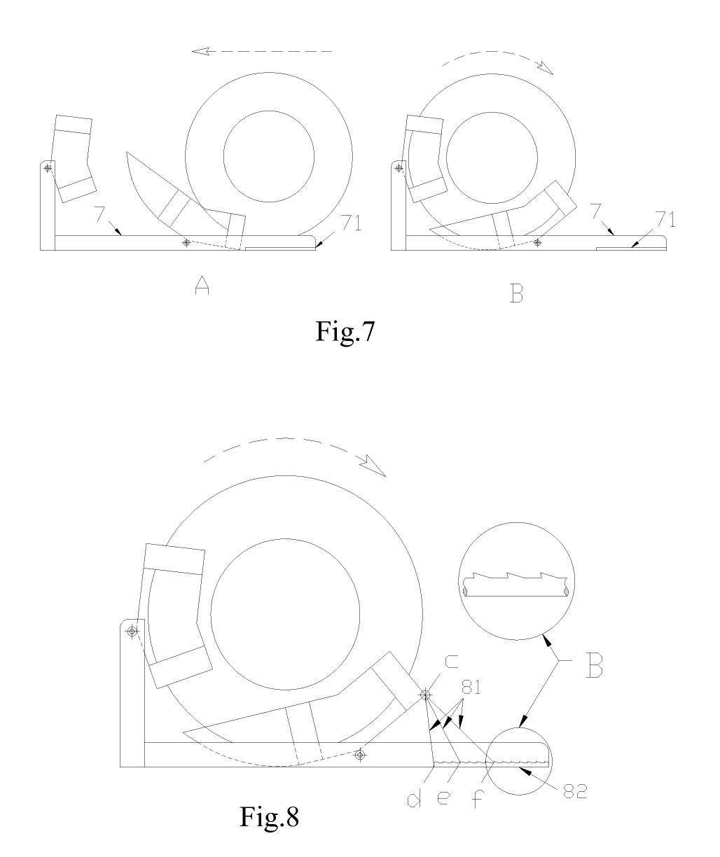

In FIG. 7 Is shown a chock with a plate 71 fixed between the side rails 7 and at the back of the chock. The plate, once the tire of the vehicle is on it, restrains the chock from moving as the tire makes contact with the lower cradle. The plate is made from metal but could be made to work in the same way if it were a flexible material such as cloth or rubber for example.

In FIG. 8 The lower cradle is shown with pivoting strap 81 in three positions and pivoting at point c. Fixed between the side rails is plate 82 that has serrated teeth. When the motorcycle is loaded into the chock, the rigid strap 81 swings down and engages the teeth of plate 82 at e or f or at the end of the plate at point d depending on how far the tire enters the chock. View B is an exploded view for the teeth on plate 82. Material of plate 82 could be made from metal, plastic, rubber or fiber.

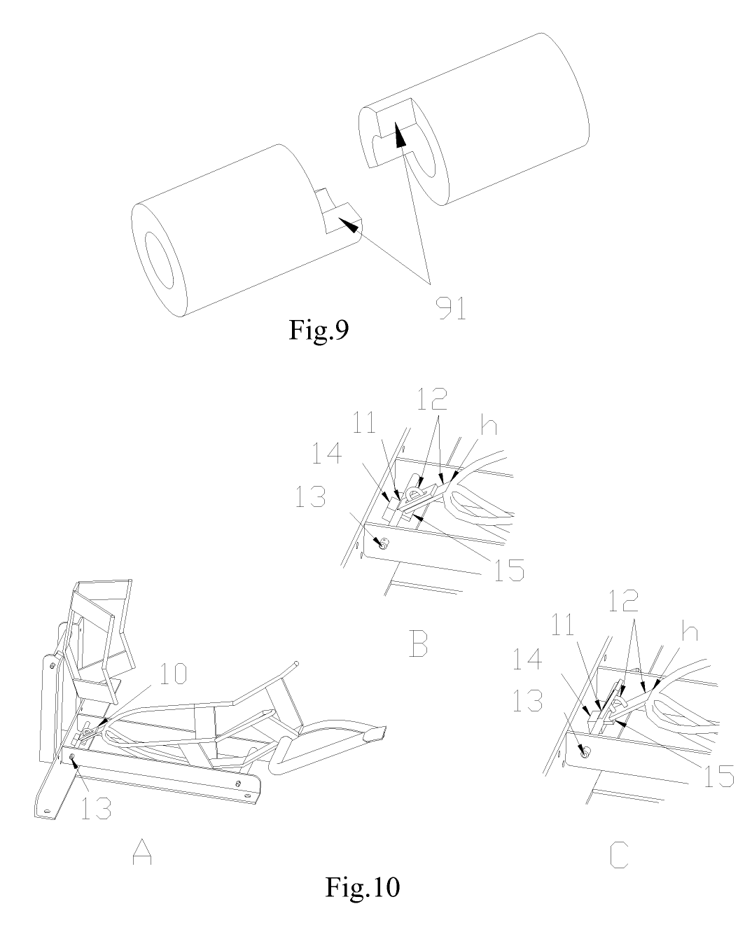

In FIG. 9 Is shown a modified hinge bushing that would limit the movement of the strap in FIGS. 3 & 5. A hinge made in this way would limit the swing of the strap and prevent the strap from swinging past vertical and under the lower cradle. The contact faces 91 would make contact preventing further rotation of the bushings

In FIG. 10 Drawn is an automatic locking mechanism used as a safety device when the motorcycle wheel is captured in the chock. The device is used to prevent inadvertent release of the motorcycle if the release mechanism were used by someone not familiar with the function of the chock such as a child. In diagram A half the safety mechanism 10 is fixed to the lower cradle and the other half pivots with pin 13. In the blown up view, diagram B, the locking mechanism is in the closed position. The hasp part 12 is a flat bar with a U ring fixed to it. The part 12 is fixed permanently to the very top and in the middle of the hoop on the lower cradle as can be seen at point h in diagram B. Part 11 is a latch which is made of a flat bar with a slot that can fit over the U ring of the hasp of part 12. The latch is fixed to pin 13 and is free to rotate. The latch has a counter weight 14 that serves to hold the latch open with gravity when in the open position. The latch also has a lug 15 fixed below the latch and to pin 13. When a motorcycle enters the chock the hasp 12 strikes the lug 15 closing the latch over the hasp. At that point, if the ejecting mechanism were utilized, the latch will restrict the lower cradle from pivoting. The hasp can be locked with a padlock. To remove the motorcycle from the chock, the latch is pulled up and is held up with the counter weight 14. The motorbike can then be removed with the ejection mechanism.

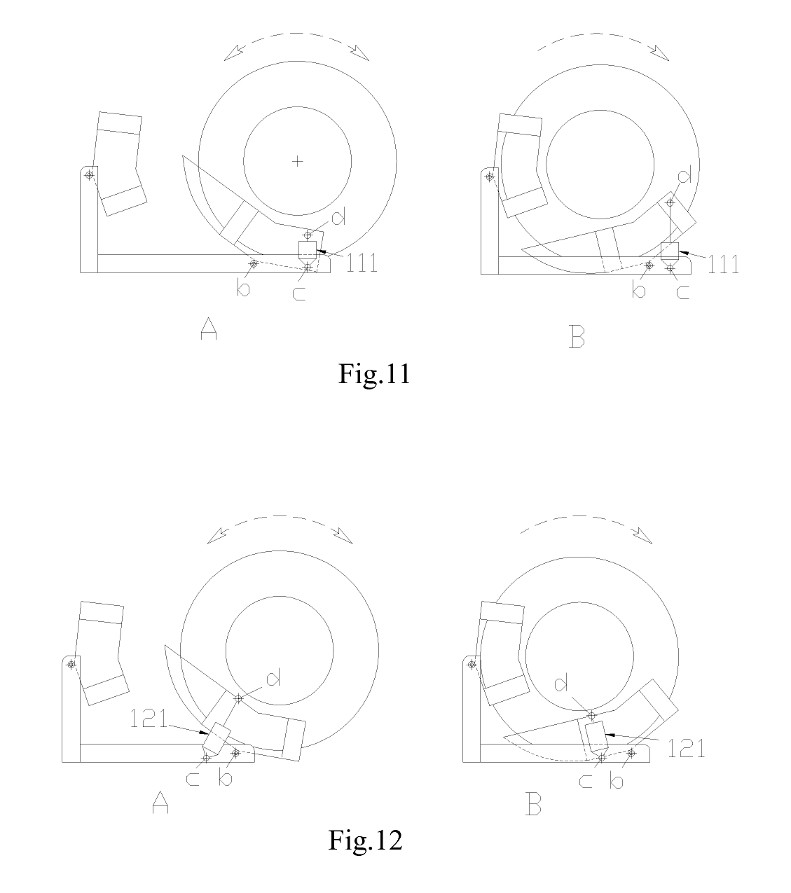

In FIG. 11 Shown is a linear actuator 111 that pulls down on the back of the pivot point of the lower cradle thus causing the lower cradle to pivot at point b ejecting the motorcycle. The actuator pivots at c and d. The actuator could be made to work with hydraulics, pneumatics, electrical, or a screw etc.

In FIG. 12 Shown is a linear actuator 121 that pushes up toward the front of the lower cradle thus causing the lower cradle to pivot at point b ejecting the motorcycle. The actuator pivots at c and d. The actuator could be made to work with hydraulics, pneumatics, electrical, or a screw etc.

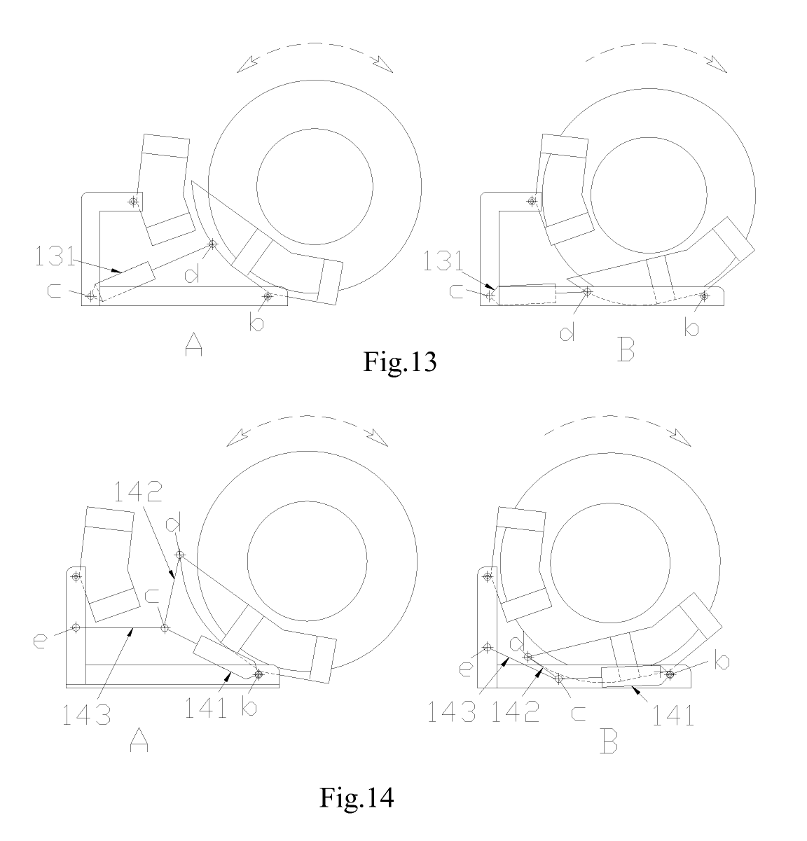

In FIG. 13 Shown is a linear actuator 131 that pushes up on the front of the lower cradle thus causing the lower cradle to pivot at point b ejecting the motorcycle. The actuator pivots at c between vertical rails and d between strap 42 of FIG. 4. The actuator could be made to work with hydraulics, pneumatics, electrical, or a screw etc.

In FIG. 14 The linear actuator 141 pivots at point b, which could be mounted between or outside the side rails of the base frame, and pushes on levers 142 & 143 at point c. Lever 142 pivots at point d on the center of the lower cradle. Lever 143 pivots at point e between the vertical rails. With this layout the cradle is moved up with very little movement of actuator 141. The actuator could be made to work with hydraulics, pneumatics, electrical, or a screw etc.

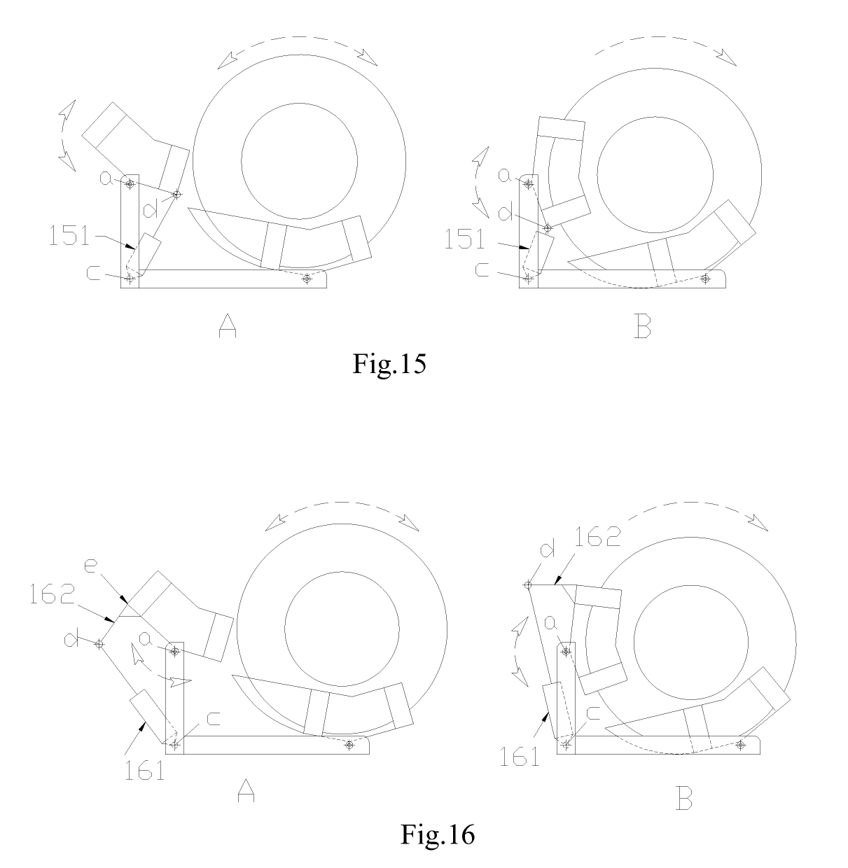

In FIG. 15 Shown is a linear actuator 151 that pushes up on the lower of the upper cradle thus causing the upper cradle to pivot at point a ejecting the motorcycle. The actuator pivots at point c between the vertical rails and at point d which is the lower center of the upper cradle. The actuator could be made to work with hydraulics, pneumatics, electrical, or a screw etc.

In FIG. 16 The linear actuator 161 which pivots at point c between the upper rails and pulls on bar 162 at pivot point d. The bar 162 is fixed to the upper cradle at point e. The actuator pulls down which causes the cradle to pivot at point a and thus ejects the motorcycle tire. The linear actuator could be made to work with hydraulics, pneumatics, electrical, or a screw etc.

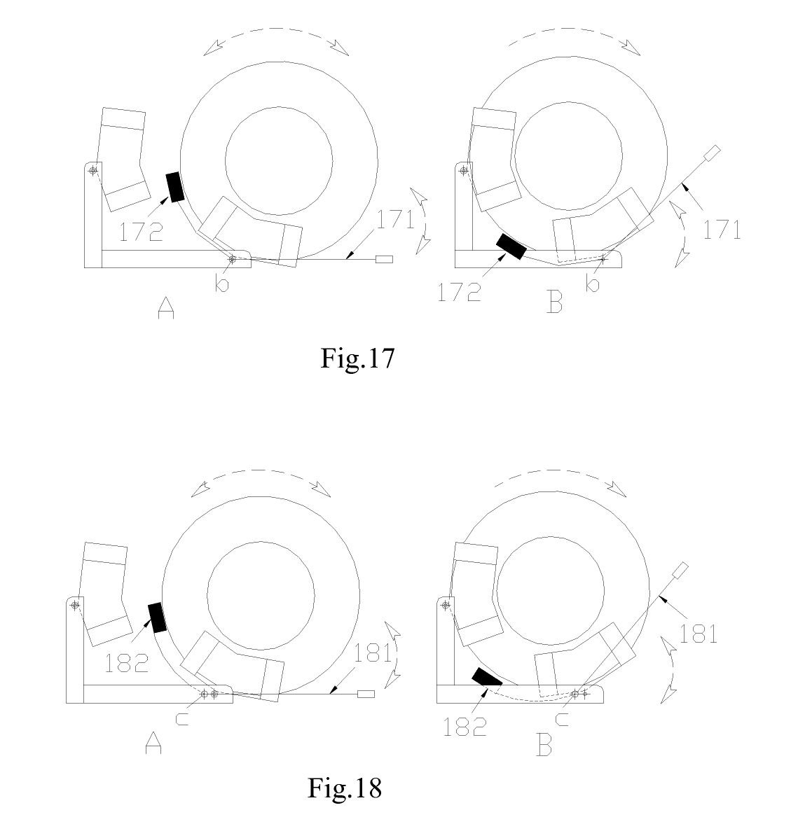

In FIG. 17 The chock shown has a lever 171 that pivots at point b which is the axis of the lower cradle. It swings independently of and is not fixed to the lower cradle. Lever 171 and pad 172 is one solid piece. The pad 172 pushes against the tire of a motorcycle ejecting it.

In FIG. 18 The chock shown has a lever 181 that pivots at point c and swings independently of the lower cradle. Lever 181 and 182 is one solid piece. The pad 182 pushes against the tire of a motorcycle ejecting it.

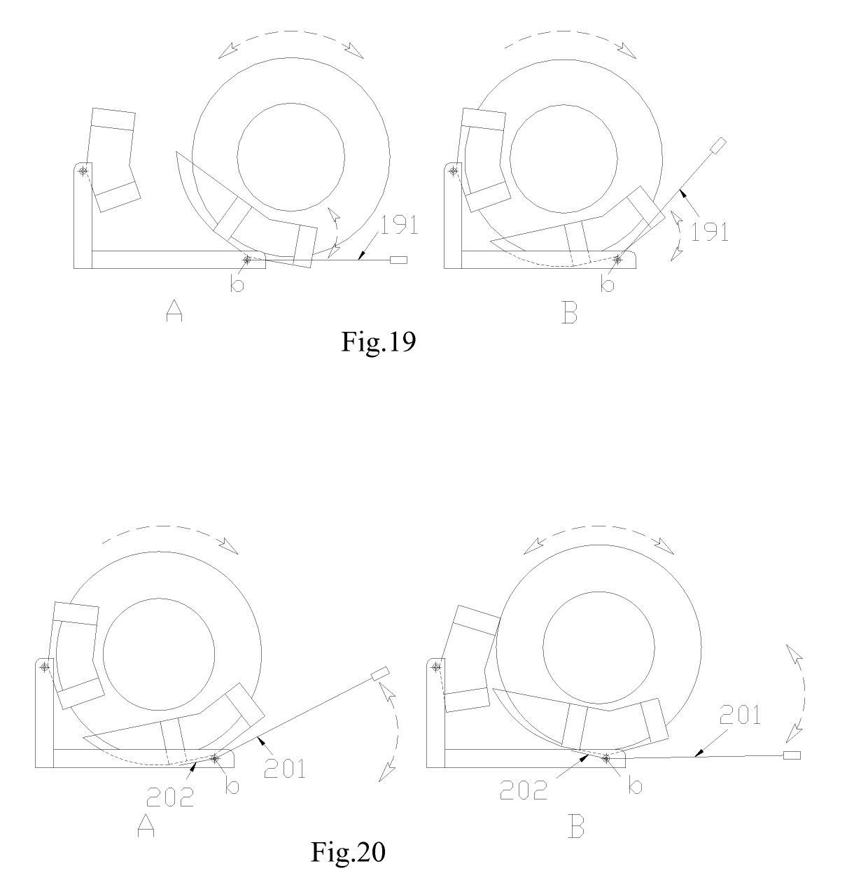

In FIG. 19 This chock has lever 191 fixed to the lower cradle at it's axis and pivots point b. The lever, when pushed down, rocks the cradle back thus ejecting the motorcycle from the chock.

In FIG. 20 The chock has a lever 201 which pivots at b which is the axis of the cradle, and is free to move up & down. At the end of the lever opposite the foot pedal is paddle 202. Lever 201 and 202 is one solid piece. When lever 201 is depressed paddle 202 pushes up on the underside of the lower cradle ejecting the motorcycle.

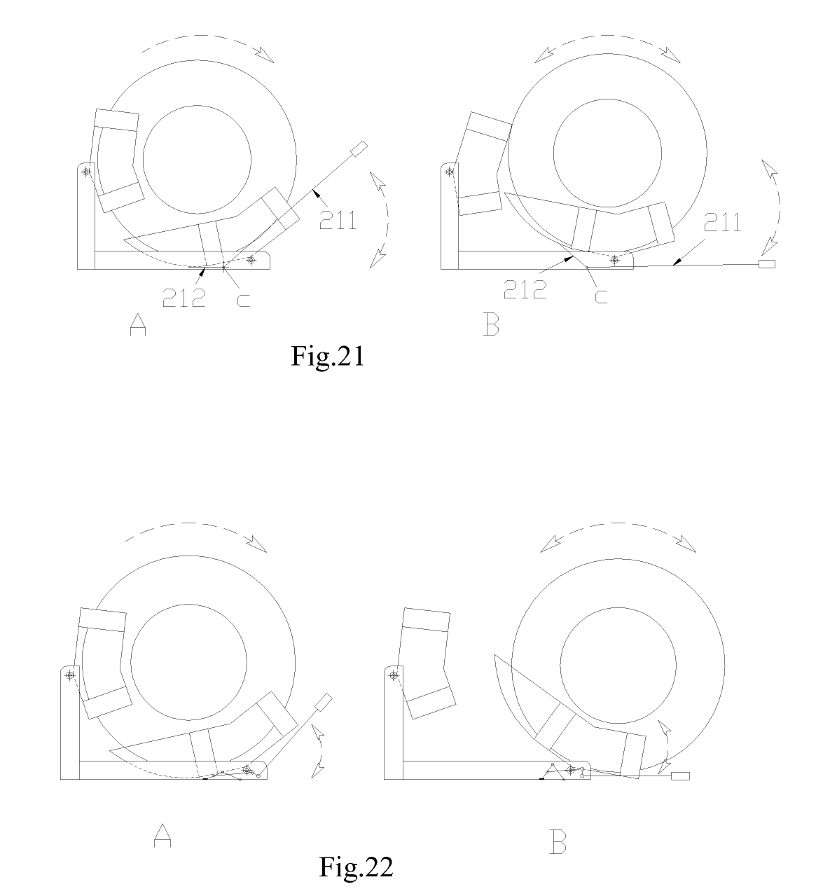

In FIG. 21 The chock has a lever 211 which pivots at c and is free to move up & down. At the end of the lever opposite the foot pedal is paddle 212. Lever 211 and 212 is one solid piece. When lever 211 is depressed paddle 212 pushes up on the underside of the lower cradle ejecting the motorcycle.

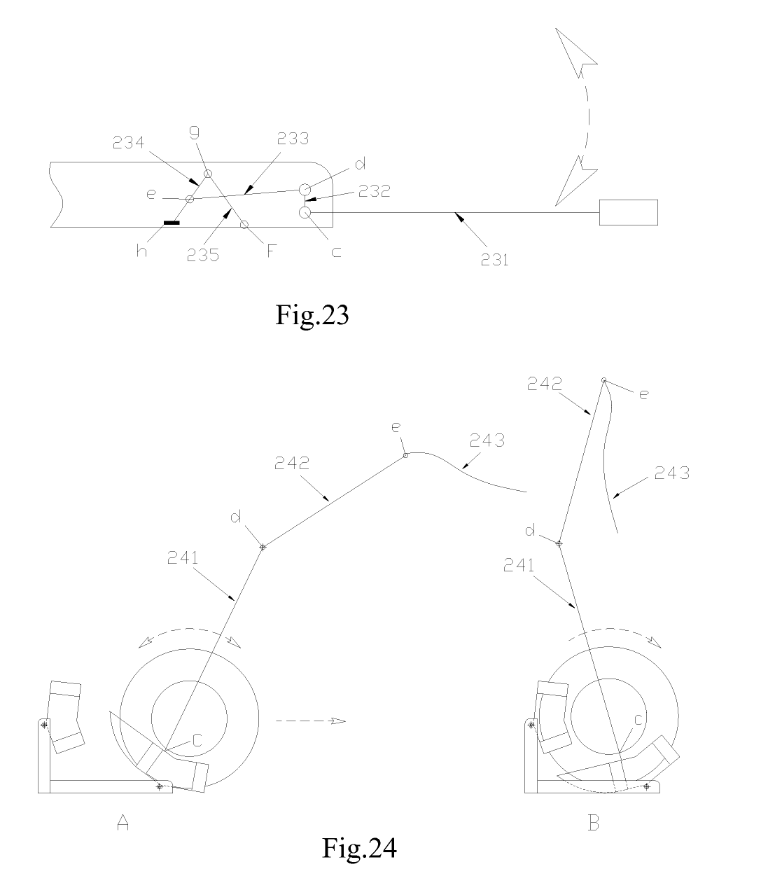

In FIG. 22 The chock has a lever which acts on two other levers which in turn causes hinged plates to push the lower cradle up thus ejecting the motorcycle (See FIG. 23) for more detail.

In FIG. 23 Shown in an enlarged view of the mechanism for the chock in FIG. 22. As lever 231 is depressed, it pivots at point c causing lever 232 to swing to the right. Lever 232 & 233 are connected with a pin at point d. As lever 233 moves to the right it pulls on hinged member 234 at point e. Member 234 in turn is connected to member 235 at hinge g. Member 234 & 235 extend across to each of the side rails of the base frame. Member 235 pivots on the side rail at point f. Hinged member 234 is free to move laterally at h. As member 234 at point h is forced closer to 235 at point f, hinge g where 234 & 235 pivots goes up and pushes the underside lower cradle up thus ejecting the motorcycle. Point h could be a pin in a slot or a pad that rests on the side rails.

In FIG. 24 The chock has a long bar 241 that is fixed to the lower cradle at point c. Bar 241 is joined to bar 242 at point d. Joint d is adjustable but once adjusted remains at the angle set. Bar 242 has a cord attached to it's uppermost end at point e. This chock releasing mechanism is utilized by the operator pulling on the hanging cord and pulling back towards himself, causing the lower cradle to pivot thereby releasing the motorcycle.

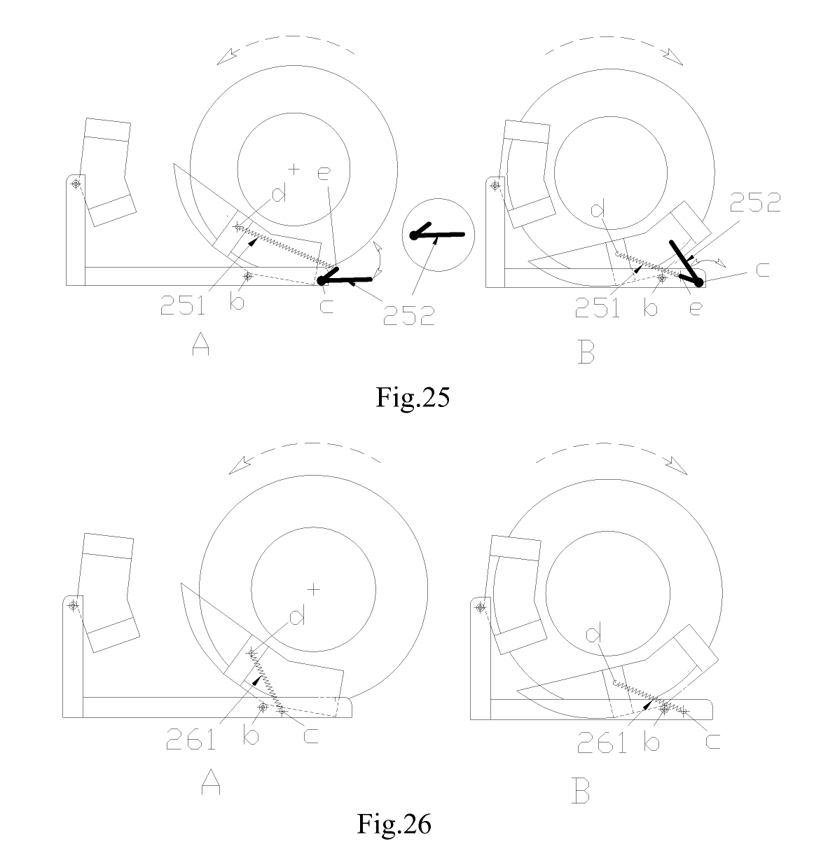

In FIG. 25 The chock shown has a lever 252 which is a vee shaped solid piece with a pivot point at its vertex. Lever 252 pivots on the side rail at point c. The lever is connected to spring 251 at pivot point e. Spring 251 pivots at point e & d. Pivot point d is located on the front vee of the lower cradle. As the lever 252 is rotated counterclockwise the tension on the spring 251 is lowered and that is the best position when loading the stand or leaving the motorcycle parked. When ejecting the vehicle the lever 252 is rotated clockwise and until it is caught by a suitable catch. The rotation of the lever causes the spring to act on the cradle with an increased leverage because of the change in angle of pivot point e in relation to point b. As the axis of the spring is moved away from pivot point b of the cradle, the rotative force acting on the cradle goes up. Depending on the setting of the spring tension a minimal backwards pull will release the motorcycle from the chock. The spring tension can be set with a turnbuckle not shown. As the chock's lower cradle rocks clockwise near the end of it's movement and the bike is released, a lug on the cradle disengages and releases the catch for the lever 252. At that point the spring tension is removed and the chock is ready to receive another vehicle with out additional input from the operator. The catch and the lug are not shown in the figure.

In FIG. 26 shown is another way to lessen the force needed to release the motorcycle from the chock. A moderately tensioned tension spring 261 in diagram A pivots at c & d. There could an identical spring on either side of the chock. One end of the spring is fixed to the side rails at point c and the other end is fixed to the lower cradle at point d. When the motorcycle wheel rolls into the lower cradle and goes over-center the spring tension is increased and the energy is conserved. As the axis of the spring 261 nears point b, the rotative leverage is reduced and the motorcycle is securely parked. While removing the vehicle and the wheel begins to move away and out of the chock, the energy stored in the spring acts on an ever increasing angle providing extra leverage on the lower cradle. Thus the motorcycle is ejected with less physical force by the operator than normally required. The pivot points and the tension of the spring can be adjustable so as to reduce or increase the force required to enter and exit the chock.

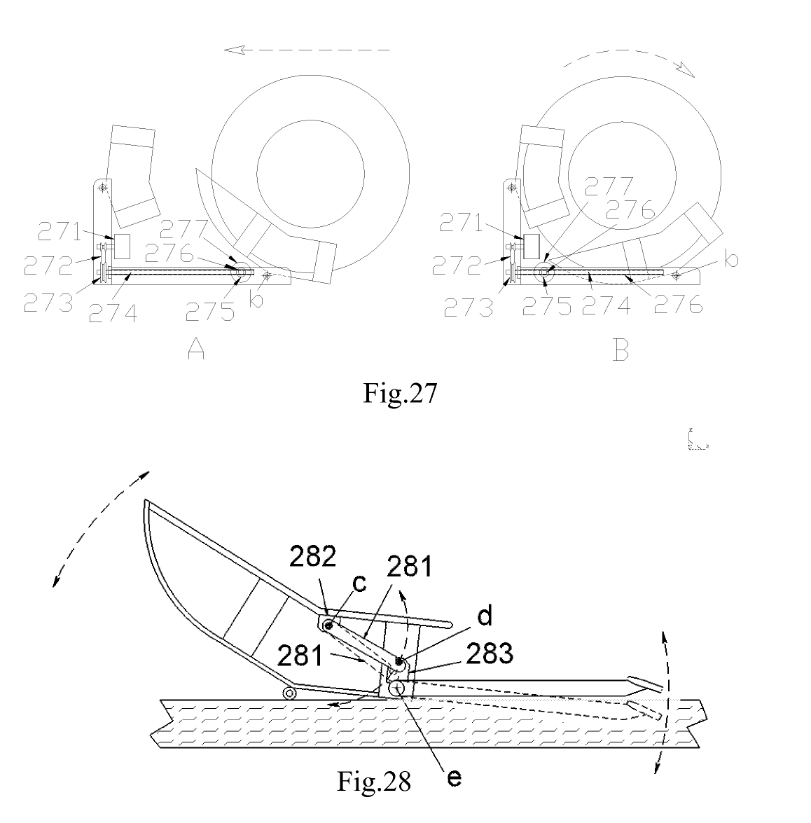

In FIG. 27 The chock has an electric motor 271 that is coupled with a toothed belt or chain 272 to pulley 273 that is fixed on the end of a long screw 274 on either side of the chock. The screw 274 is threaded into a nut 275 on either side of the chock. The nut 275 is fixed to shaft 276 that crosses from one side of the chock to the other through the side rails. Shaft 275 does not rotate but rides in slot 276 that is made in each of the side rails. Shaft 275 has bearings that support rolling elements 277 that push on the underside of the lower cradle. The rolling elements are free to rotate as they push on the lower cradle reducing friction. As the motor is switched on in diagram B the threaded screw turns, causing the rolling member to move toward the back of the chock between the side rails (see diagram A) forcing the lower cradle up, releasing the motorcycle.

In FIG. 28 shown is an automatic quick release link between the lower cradle and the foot lever. Link 281 has a hole for pivoting at one end and an open slot at the opposite end. The link 281 is free to pivot at c which is connected to the lower cradle with lug 282. The other end of the link 281 catches at point d which has a round stud protruding. The round stud at point d is fixed to lug 283 which is fixed to the foot lever. The foot lever is free to pivot on center at e. As the lower cradle is made to rock back to the position shown, the foot wants to continue going down depicted by the hidden lines. As the lever hits the floor it pivots counter clockwise in relation to the lower cradle as illustrated by the hidden line with arrows at the right. When that happens, link 281 disengages at point d and drops down, because of gravity, leaving the foot lever free to pivot. When released, the foot lever lays flat on the floor or ground. This is a safety device which prevents accidental ejection of the motorcycle should anyone inadvertently depress the foot lever. When the user needs to eject the motorcycle, the link 281 must be swung up to engage the stud at d which connects the lower cradle to the foot lever. The mechanism works equally well if the link is turned end for end and pivots at point d and catches at point c.

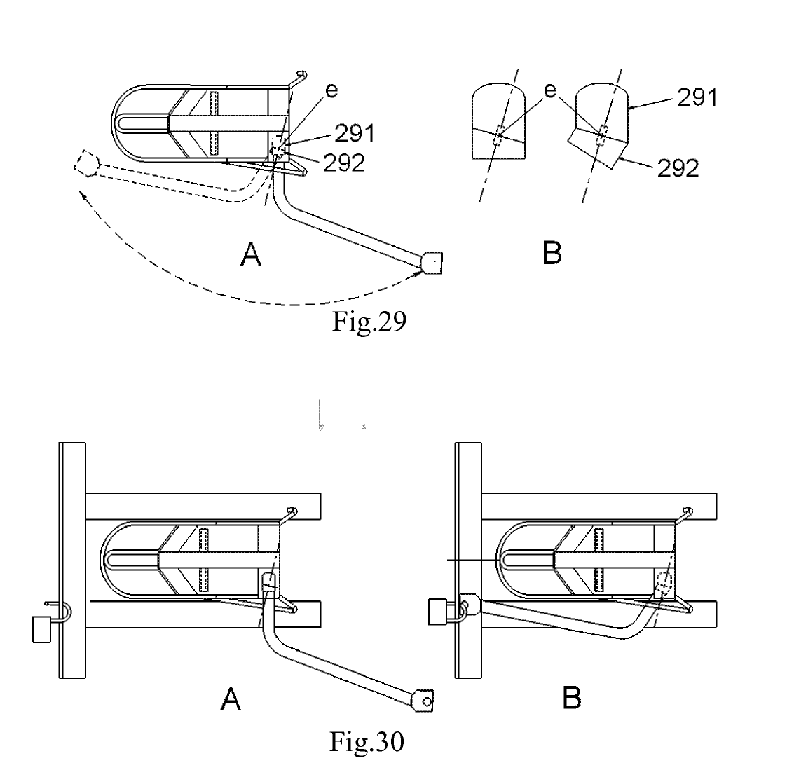

In FIG. 29 as mentioned in the previous paragraph, the foot lever can be made to pivot to take advantage of the quick release safety device. In this case the barrel hinge has an angle mitered between each half of the hinge. The joint is made of two pieces of short shaft. 291 is fixed to the lower cradle and 292 is fixed to the foot lever. They pivot on a pin at point e along the axis depicted by the center lines in diagram A. The mitered angle the shafts 291 and 292 have, causes the foot lever when swung forward to swing inward and toward the base of the stand. In diagram B the pivot joint can be seen when the foot lever is in the normal position and when the foot lever is swung forward. In FIGS. 30 A and B the chock is shown without the upper cradle and vertical rails. The foot lever, in the normal position A, extends out occupying more floor space and could be an obstruction to pedestrians. In diagram B the foot lever is swung forward and has appropriate holes allowing the lever to be locked as needed.

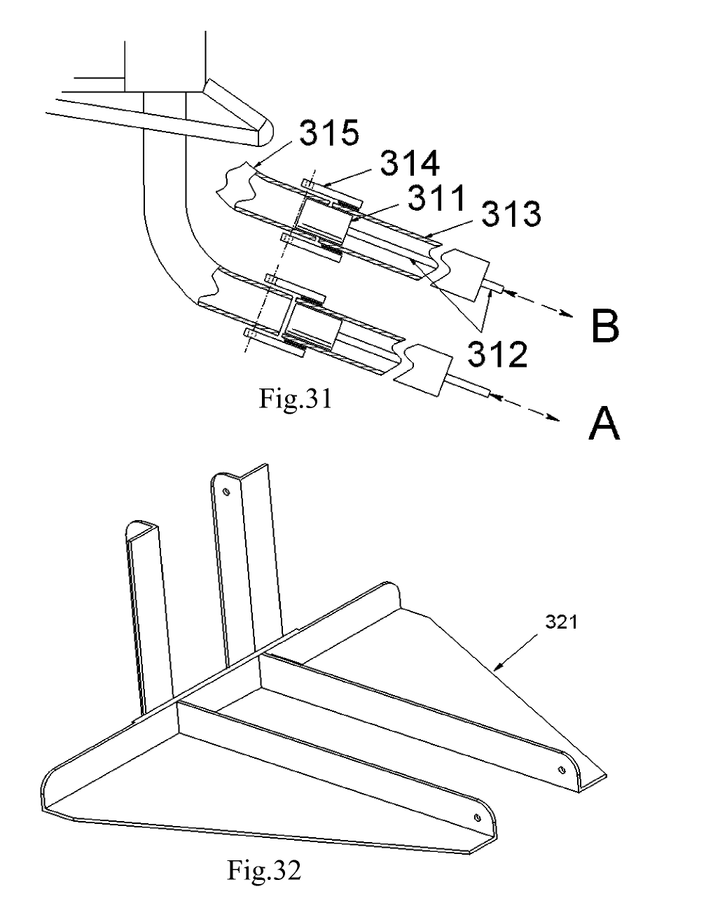

In FIG. 31 shown is another method used to automatically disconnect the action of the foot lever from the lower cradle so as to prevent accidental ejection of a motorcycle. In diagram A piston 311 is connected to rod 312, both of which are free to move back and forth inside foot lever tube 313 as depicted by the hidden lines with arrows. There is a spring not shown which pulls the piston and rod assembly towards the outboard end of tube 313. Tube 313 has clevis 314 fixed to it. Clevis 314 pivots on a pin along the axis of the center line shown. The pin, not shown, passes through the tube 315 and is fixed to it. The normal position of the foot lever is shown in diagram B. A spring pulls the piston assembly free of tube 315. In use, the rod 312 would be pushed toward the lower cradle, usually with the operator's foot, causing the piston 311 to inter into and engage tube 315 and 313 at the same time as shown in diagram A. With both pipes of the foot lever inter-connected with the piston, the cradle can be rotated and the motorcycle ejected. Once the motorcycle is ejected and the operator's foot leaves the foot lever, the pressure of the spring will push the piston free of tube 315 disengaging the foot lever automatically.

In FIG. 32 is a method of making the base with folded sheet metal instead of angle irons. By cutting sheet metal to the appropriate shape, the base 321 can be bent eliminating the need for welding.

### DESCRIPTION OF OTHER RELATED MECHANISMS

1. A chock can have a torsion spring wound around each end of the shaft of the lower cradle where space permits. The spring is strongly pretension-ed, having one end attached to the side rails and the other end connected to the shaft of the lower cradle. As a motorcycle is parked in the chock, the springs are further tensioned axially until the tire stops as it is seated and mates with the upper cradle. At that moment, the latching mechanism as described in FIG. 21 locks the upper cradle in the closed position. The spring being a conservative force will help eject the motorcycle when trying to eject the motorcycle from the chock.

2. Another locking mechanism is provided by using a sliding bolt and a disc. The disc is fixed to the end of the shaft of the lower cradle. The disc has some material removed so as not to interfere with the rotation of the lower cradle against the ground. The disc has a “D” shape with the flat part orientated towards the ground. The disc has a hole that coincides with the axis of a locking bolt in the side rails of the chock when the chock is in the closed position. The bolt is spring loaded with an angle formed on it's end and is placed into a bushing fixed to the side rails. The bolt is not free to rotate but is free to move in and out on it's axis. The axis of the bolt is parallel to the axis of the pivot shaft of the lower cradle. As the motorcycle is loaded into the chock, the flat portion of the disc pushes the bolt away and into the bushing fixed to the side rails. When the hole of the disc and the locking bolt line up, the spring acting on the locking bolt pushes it into the hole of the disc, locking the lower cradle from rotating further. To release the motorcycle from the chock, the locking bolt has a cam shape under it's head that bears against a lever that has a cam on it which faces outward and away from the chock. The lever with a cam shape is rotated and can be moved with the operator's foot. As the lever is swung the bolt is withdrawn from the latch plate and the lower cradle is free to rotate. As the lower cradle rotates and the motorcycle is removed, the disc hits on the lever and the locking bolt is reset.

1. A motorcycle chock with a pivoting lower cradle that has a tire restraining portion protruding to it's uppermost front closed end comprising of a hoop, closed bucket, or bar.

2. A motorcycle chock with a pivoting lower cradle that has a strap fixed to the back lower entrance comprising of either flexible material or solid bar with or without a hinge.

3. A motorcycle chock with a foot lever comprising of a straight or angular barreled hinge joint connecting between foot pedal and the lower cradle.

4. A motorcycle chock with an automatically disengaging link comprising of a bar with a hole at one end and a slot at the other end connecting between the lower cradle by means of a lug and pin to the foot lever by means of another lug and pin.
